(19) United States
(12) Patent Application Publication
(10) Pub. No.: US 2006/0164991 A1
(43) Pub. Date: Jul. 27, 2006

(54) World wide port name embedding method and interface for network transmission control chip

(75) Inventor: Chih-Wei Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/067,388

(22) Filed: Feb. 25, 2005

(30) Foreign Application Priority Data
Jan. 18, 2005 (TW) 094101394
Dec. 31, 2004 (TW) 093141863

(51) Int. Cl. H04J 1/16; H04J 3/14

(52) U.S. Cl. 370/235

(57) ABSTRACT

A world wide port name embedding method and interface is proposed, which is designed for use in conjunction with a network transmission control chip for the purpose of embedding a world wide port name (WWPN) to the network transmission control chip, and which is characterized by that the world wide port name embedding procedure can be performed under the condition that the driver program is readily loaded in the network transmission control chip, rather than utilizing an independent WWPN embedding routine that runs under the condition that the driver program is unloaded in the network transmission control chip. This feature can help prevent conflict in system configurations due to multiple initialization processes on the network transmission control chip, and also allows the implementation to be more simplified and cost-effective than the prior art.

### BACKGROUND OF THE INVENTION

1. Field of the Invention

This invention relates to information technology (IT), and more particularly, to a world wide port name embedding method and interface which is designed for use in conjunction with a network transmission control chip, such as an FCP (Fibre Channel Protocol) compliant chip used in a SAN (Storage Area Network) system, for the purpose of allowing the user to set a WWPN (World Wide Port Name) and embed it into the network transmission control chip.

2. Description of Related Art

SAN (Storage Area Network) is a networking architecture which is designed for connecting high-volume data storage units, such as RAID (Redundant Array of Independent Disks) units, to a network system so as to allow network servers or workstations to gain access via the network system to these high-volume storage units. SAN systems typically utilize a high-speed data transmission interface, such as FCP (Fibre Channel Protocol) compliant interface, for data transmission between RAID units and servers.

In the application of a SAN system, an important prerequisite task is to embed a world wide port name (WWPN) to a network transmission control chip that is used for the control of data transmission between servers and RAID units in the SAN system. The data of WWPN allows network servers to be able to find the location where the requested data are stored and gain access to the data via FCP-compliant data transmission channels.

Presently, a conventional method for embedding a world wide port name to a network transmission control chip includes a first step of loading the driver program into the chip and performing an initialization process; and then after the initialization is completed, a WWPN embedding routine is executed under the driver program to allow the user to input the data of WWPN to the driver program. The inputted data of WWPN is then written into a built-in non-volatile random-access memory (NVRAM) unit in the network transmission control chip.

One drawback to the foregoing method, however, is that since the execution of the WWPN embedding routine is also an initialization process, it would be highly likely to cause conflict in the system configuration due to multiple initialization processes (one by the driver program and the other by the WWPN embedding routine), thus undesirably resulting in the network transmission control chip unable to operate normally.

One solution to the foregoing problem is to design an independent WWPN embedding routine that runs without the driver program. In the embedding procedure, the driver program is cleared from the network transmission control chip, and then the independent WWPN embedding routine is executed without the driver program for the user to set a WWPN and embed it to the control chip. This solution can help avoid multiple initialization processes on the network transmission control chip, thus allowing the network transmission control chip to operate normally without conflict in system configurations.

One drawback to the foregoing solution, however, is that since the independent WWPN embedding routine is executed under the condition that the driver program is unloaded in the network transmission control chip, it requires the independent WWPN embedding routine to self contain an initialization program which requires additional efforts in firmware development, and therefore is quite tedious and costly to implement.

### SUMMARY OF THE INVENTION

It is therefore an objective of this invention to provide a world wide port name embedding method and interface for network transmission control chip which can help prevent conflict in system configurations due to multiple initialization processes on the network transmission control chip during the world wide port name embedding procedure.

It is another objective of this invention to provide a world wide port name embedding method and interface for network transmission control chip which represents a more simplified and cost-effective solution than the prior art for the embedding of world wide port name into a network transmission control chip.

The world wide port name embedding method and interface according to the invention is designed for use in conjunction with a network transmission control chip, such as an FCP (Fibre Channel Protocol) compliant chip used in a SAN (Storage Area Network) system, for the purpose of allowing the user to set a WWPN (World Wide Port Name) and embed it into the network transmission control chip.

The world wide port name embedding method and interface according to the invention is characterized by that the world wide port name embedding procedure can be performed under the condition that the driver program is readily loaded in the network transmission control chip, rather than utilizing an independent WWPN embedding routine that runs under the condition that the driver program is unloaded in the network transmission control chip. This feature can help prevent conflict in system configurations due to multiple initialization processes on the network transmission control chip, and also allows the implementation to be more simplified and cost-effective than the prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the world wide port name embedding interface for network transmission control chip according to the invention.

### DETAILED DESCRIPTION OF PREFERRED EMBODIMENTS

The world wide port name embedding method and interface for network transmission control chip according to the invention is disclosed in full details by way of preferred embodiments in the following with reference to the accompanying drawing.

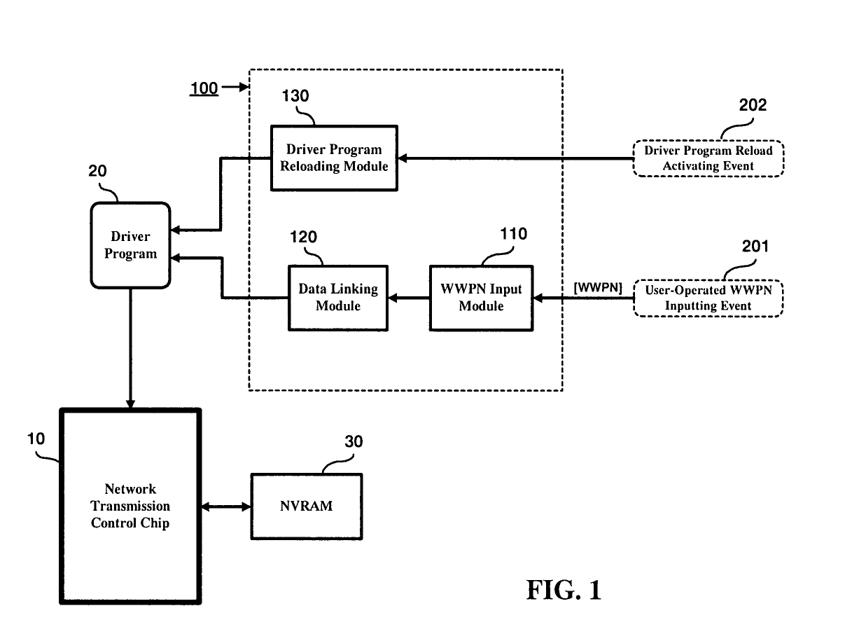

FIG. 1 is a schematic diagram showing the application architecture and modularized object-oriented component model of the world wide port name embedding interface according to the invention (as the part enclosed in the dotted box indicated by the reference numeral 100). As shown, the world wide port name embedding interface of the invention 100 is designed for use as a user interface in conjunction with a network transmission control chip 10 running on a dedicated driver program 20 for the purpose of allowing the user to set a world wide port name (WWPN) and embed it into the network transmission control chip 10 via the driver program 20, i.e., writing a WWPN into a built-in non-volatile random-access memory (NVRAM) unit 30 in the network transmission control chip 10, so as to allow network servers/workstations (not shown) to use the WWPN to gain access via FCP (Fibre Channel Protocol) compliant data transmission channels under control by the network transmission control chip 10 to a RAID unit (not shown) in a SAN system.

In practical implementation, for example, the network transmission control chip 10 is an FCP (Fibre Channel Protocol) compliant control chip designed for SAN (Storage Area Network) applications, such as an FCP-compliant control chip developed by the Qlogic Corporation of USA. However, it is to be noted that the invention is not limited to the application on FCP-compliant control chips and can be applied to various other types of network transmission control chips having similar functionality.

As shown in FIG. 1, the modularized object-oriented component model of the world wide port name embedding interface of the invention 100 comprises: (a) a world wide port name input module 110; (b) a data linking module 120; and (c) a driver program reloading module 130. In practical implementation, for example, the world wide port name embedding interface of the invention 100 can be fully realized by a computer program which is integrated as an add-on firmware module to the driver program 20 of the network transmission control chip 10.

The world wide port name input module 110 is capable of responding to a user-operated world wide port name inputting event 201 after the driver program 20 is loaded into the network transmission control chip 10 by receiving the user-input world wide port name [WWPN]. In practical implementation, for example, the user can utilize a keyboard or an equivalent input device (not shown) to initiate the world wide port name inputting event 201 for inputting the data of [WWPN].

The data linking module 120 is capable of linking the data of [WWPN] inputted by the world wide port name input module 110 to the driver program 20 so as to allow the data of [WWPN] to be loadable into the network transmission control chip 10 via the driver program 20.

The driver program reloading module 130 is capable of responding to a driver program reload activating event 202 by performing a reloading procedure on the driver program 20. In the reloading procedure, the driver program 20 is first cleared from the network transmission control chip 10, and then the driver program 20 is reloaded into the network transmission control chip 10 together with the linked data of [WWPN]. When the driver program 20 is readily reloaded in the network transmission control chip 10, the driver program 20 also writes the data of [WWPN] into the built-in NVRAM unit 30 in the network transmission control chip 10.

Referring to FIG. 1, in actual operation, when the user wants to set a world wide port name for embedding to the network transmission control chip 10, the user can first load the driver program 20 into the network transmission control chip 10; and then after the driver program 20 completes an initiation process, the user can utilize the world wide port name input module 110 to initiate a user-operated world wide port name inputting event 201, i.e., utilizing a keyboard or an equivalent input device (not shown) to input the data of the world wide port name. The world wide port name input module 110 then stores the user-inputted data of world wide port name to a variable [WWPN]. Subsequently, the data linking module 120 is activated to link the data of [WWPN] inputted by the world wide port name input module 110 to the driver program 20. Next, the user is prompted to initiate a driver program reload activating event 202, which causes the driver program reloading module 130 to respond by performing a reloading procedure on the driver program 20. In the reloading procedure, the driver program 20 is first cleared from the network transmission control chip 10, and then the driver program 20 is reloaded into the network transmission control chip 10 together with the linked data of [WWPN]. When the driver program 20 is reloaded in the network transmission control chip 10, the driver program 20 also writes the data of [WWPN] into the built-in NVRAM unit 30 in the network transmission control chip 10, so that the data of [WWPN] is permanently embedded in the network transmission control chip 10. As the data of [WWPN] is embedded in the network transmission control chip 10, it allows network servers/workstations (not shown) to use the world wide port name to gain access via FCP (Fibre Channel Protocol) compliant data transmission channels under control by the network transmission control chip 10 to a RAID unit (not shown) in a SAN system.

In conclusion, the invention provides a world wide port name embedding method and interface for use with a network transmission control chip for the purpose of embedding a world wide port name to the network transmission control chip, and which is characterized by that the world wide port name embedding procedure can be performed under the condition that the driver program is readily loaded in the network transmission control chip, rather than utilizing an independent WWPN embedding routine that runs under the condition that the driver program is unloaded in the network transmission control chip. This feature can help prevent conflict in system configurations due to multiple initialization processes on the network transmission control chip, and also allows the implementation to be more simplified and cost-effective than the prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A world wide port name embedding method for use on a network transmission control chip running on a driver program for the purpose of embedding a world wide port name into the network transmission control chip;
the world wide port name embedding method comprising:
when the driver program is loaded in the network transmission control chip, responding to a user-operated world wide port name inputting event by receiving the user-input data of world wide port name;
linking the user-inputted data of world wide port name to the driver program so as to allow the world wide port name to be loadable into the network transmission control chip via the driver program; and
performing a reloading procedure on the driver program, wherein the driver program is first cleared from the network transmission control chip and then reloaded into the network transmission control chip together with the data of world wide port name linked by the data linking module.

2. The world wide port name embedding method of claim 1, wherein the network transmission control chip is a FCP (Fibre Channel Protocol) compliant control chip devised for SAN (Storage Area Network) applications.

3. The world wide port name embedding method of claim 1, wherein the driver program reloading module writes the data of world wide port name into a built-in non-volatile random access memory in the network transmission control chip.

4. A world wide port name embedding interface for use with a network transmission control chip running on a driver program for the purpose of embedding a world wide port name into the network transmission control chip;
the world wide port name embedding interface comprising:
a world wide port name input module, which is capable of responding to a user-operated world wide port name inputting event after the driver program is loaded into the network transmission control chip by receiving the user-input data of world wide port name;
a data linking module, which is capable of linking the data of world wide port name inputted by the world wide port name input module to the driver program so as to allow the world wide port name to be loadable into the network transmission control chip via the driver program; and
a driver program reloading module, which is capable of responding to a driver program reload activating event by performing a reloading procedure on the driver program wherein the driver program is first cleared from the network transmission control chip and then reloaded into the network transmission control chip together with the data of world wide port name linked by the data linking module.

5. The world wide port name embedding interface of claim 4, wherein the network transmission control chip is a FCP (Fibre Channel Protocol) compliant control chip devised for SAN (Storage Area Network) applications.

6. The world wide port name embedding interface of claim 4, wherein the driver program reloading module writes the data of world wide port name into a built-in non-volatile random access memory in the network transmission control chip.
